(19) United States
(12) Patent Application Publication
(10) Pub. No.: US 2008/0216218 A1
(43) Pub. Date: Sep. 11, 2008

(54) Chemically protective articles with separable adsorptive liner

(76) Inventors: Ronald James McKinney, Wilmington, DE (US); Stephanie Michelle Tew, Salem, VA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/714,374

(22) Filed: Mar. 5, 2007

(51) Int. Cl. A62B 17/00

(52) U.S. Cl. 2/457

(57) ABSTRACT

A chemically protective article comprising an outer shell and a separable adsorptive liner is provided. When the adsorption sites of the liner become saturated, the liner alone may be replaced without discarding the entire article. The liner also provides additional protection from harmful species should the outer shell be breached. Such chemically protective articles include garments, shelters, and coverings.

### TECHNICAL FIELD

The present invention relates to a chemically protective garment, shelter, or covering comprising an outer shell and a separable liner that contains adsorptive material. When the adsorption sites of the liner become saturated, the liner alone may be replaced without discarding the entire garment. The liner also provides additional protection from harmful species should the outer shell be breached.

### BACKGROUND

Individuals who may come in contact with hazardous chemicals may wear garments utilizing a variety of technologies for protection depending on specific needs. The garment may include a layer of a material like activated carbon that is capable of adsorbing hazardous vapors and liquids. Chemically protective garments based on activated carbon are disclosed, for example, in U.S. Pat. No. 4,510,193. Air permeable protective garments for military personnel that include a layer containing activated carbon are described by, for example, Schreuder-Gibson et al. in MRS Bulletin 28(8), 574-578 (2003). Chemically protective garments containing both an adsorbent layer and a semipermeable membrane are disclosed, for example, in PCT Application WO 2005049147. Chemically protective gloves containing both an adsorbent layer and an impermeable layer are disclosed in, for example, U. S. Patent Application Publication 2007/0000017.

Activated carbon has a limited capacity, resulting in a significant reduction in protection once its adsorptive sites are saturated. Depending on the working environment, the adsorbing capability may be satisfactory for several months, or at the other extreme, for only a few seconds or minutes if exposed to liquids or high vapor concentrations.

The present invention provides a chemically protective garment comprising an outer shell and a separable adsorptive liner that provides additional protection from harmful species should the outer shell be breached and that, when the adsorption sites of the liner become saturated, may be replaced by itself without discarding the entire garment.

### SUMMARY OF THE INVENTION

The present invention provides a chemically protective article comprising a shell and a separable liner wherein the separable liner comprises adsorptive material and wherein the chemically protective article is a garment, shelter, or covering.

These and other aspects of the present invention will be apparent to one skilled in the art in view of the following description and the appended claims.

### BRIEF DESCRIPTION OF THE DRAWINGS

FIG. 1 is a schematic diagram showing front and back views of the structure of a garment comprising one type of shell and separable liner according to an embodiment of the present invention.

### DETAILED DESCRIPTION

In the context of this disclosure, a number of terms shall be utilized.

The term “membrane” as used herein denotes a discrete, thin structure that moderates the transport of species in contact with it, such as gas, vapor, aerosol, liquid and/or particulates. Examples of membranes include without limitation film, plastic sheeting, synthetic barriers, layers, laminar structures, woven fabric, and nonwoven sheet.

The term “permeable” as used herein means allowing the passage of liquids or gases.

The term “selectively permeable” as used herein means allowing passage of certain species but acting as a barrier to others.

The term “shell” or, equivalently, “outer shell” as used herein means the outermost layer of a finished article such as a garment.

The term “separable liner” as used herein denotes a liner that can be readily attached to and detached from the shell.

The term “harmful to human health” as used herein means causing injury to humans as a consequence of acute or chronic exposure through dermal contact, ingestion, or respiration.

The term “polyester” as used herein means a condensation polymer in which more than 50 percent of the groups connecting repeat units are ester groups. Thus polyesters may include polyesters, poly(ester-amides) and poly(ester-imides), so long as more than half of the connecting groups are ester groups. The proportion of ester connecting groups can be estimated to a first approximation by the molar ratios of monomers used to make the polyester.

The term “PET” as used herein the term means a polyester in which at least 80, more preferably at least 90, mole percent of the diol repeat units are from ethylene glycol and at least 80, more preferably at least 90, mole percent of the dicarboxylic acid repeat units are from terephthalic acid.

The term “PPT” as used herein means a polyester in which at least 80, more preferably at least 90, mole percent of the diol repeat units are from 1,3-propanediol and at least 80, more preferably at least 90, mole percent of the dicarboxylic acid repeat units are from terephthalic acid.

The term “polyamide” as used herein means a condensation polymer in which more than 50 percent of the groups connecting repeat units are amide groups. The proportion of amide connecting groups can be estimated to a first approximation by the molar ratios of monomers used to make the polyamide.

The term “nylon” as used herein means a polyamide other than an aramid.

The term “aramid” as used herein means an aromatic polyamide, wherein at least 85% of the amide (—CONH—) linkages are attached directly to two aromatic rings.

The term “modacrylic” as used herein means a polymer composed of less than 85% but at least 35% by weight of acrylonitrile.

The term “tricot” as used herein means a knit fabric formed by interloping adjacent, parallel yarns.

The term “(co)polymers” as used herein means “homopolymers and copolymers.”

The term “laminate” as used herein means a material comprising two or more parallel layers of material that are at least partially bonded to each other.

The term “continuous” as used herein to describe bonding between two items means that the entire surface area of one item is bonded to the surface of the other item. The term “discontinuous” as used herein means that part of the surface area on one item is not bonded to the surface of the other item.

The term “reversible connecting means” as used herein indicates a connecting means that can be used repeatedly to connect and disconnect items together, without damaging either the items being connected or the connecting means itself. Thus, a permanent glue would not be a reversible connecting means, but a zipper or hook and loop fastener would.

The present invention provides a chemically protective article comprising an outer shell and a separable liner that comprises adsorptive material. In one embodiment, the finished article further comprises a chemically protective membrane which may be essentially impermeable or selectively permeable (“SPM”). Finished articles include chemically protective garments, shelters, and covers.

### Separable Liner

The separable liner comprises an adsorbent material, that is, a material capable of adsorbing species against which protection is desired. Adsorbent materials may be inorganic, such as one or more of silica gel, alumina or other metal oxides, metal hydroxides, molecular sieves, and zeolites; or they may be organic, such as activated carbon. Regardless of the composition of the adsorbent material, the surface area should be maximized in order to minimize the weight of adsorbent that is needed. Activated carbon is a preferred adsorbent. The activated carbon may be in the form of powder, beads, granules, nanotubes, fiber, or cloth. The activated carbon may be attached to a woven or non-woven fabric or distributed in a foam supported on a fabric. Woven or knit activated carbon cloth is a preferred form of adsorbent; one commercially available example is Zorflex® activated carbon cloth produced by Calgon Carbon Corporation (Pittsburgh, Pa., USA). Though the carbon cloth may be used as a liner by itself, it is preferred to bond it to another lightweight woven or knit liner fabric such as a tricot. This increases strength and prevents direct contact between the activated carbon and the wearer's skin, and, in a garment, minimizes transfer of carbon particles to the wearer's skin. Bonding between the carbon cloth and the liner fabric may be continuous (i.e., the entire surface area of the carbon cloth is bonded to the liner fabric) or discontinuous (i.e., some area of the carbon cloth is not bonded to the liner fabric). Bonding is accomplished by any appropriate connecting means used in the garment textiles industry, including without limitation adhesive, stitching, zippers, snaps, buttons, and string. Bonding by adhesives in discontinuous patterns such as dots is preferred.

The adsorptive liner provides back-up protection in the event that the outer shell or the protective membrane is breached. In addition, in a garment which cannot be laundered or can be laundered only with great difficulty, the adsorptive liner is useful in adsorbing body odors

Furthermore, when the useful life of the liner approaches its end because of saturation of the adsorptive sites, the liner alone may be replaced without discarding the entire garment. In some cases, the liner may be subjected to a process for regenerating the adsorptive capability and then rejoined to the garment. For example, the adsorptive capacity of a liner comprising activated carbon may be regenerated by as much as 90 to 95% capacity by heating it under vacuum or exposing it to steam.

### Outer Shell

The shell comprises woven fabric or non-woven fabric (e.g., nonwoven sheet structures created by spun bonded/melt blown processes or by electrospinning as described in, e.g., Z.-M. Huang et al., Composites Science and Technology (2003), 63, 2223-2253). Shell fabrics may be prepared from any synthetic or natural fiber suitable for the intended end use and are typically selected from the group consisting of nylons, cotton, polyesters, modacrylic, aramids, and blends containing any of these. One commonly used blend is a blend of nylon and cotton fibers (“NYCO”). Preferred polyesters are PET (co)polymers and blends and PPT (co)polymers and blends. A suitable aramid may be in the form of a copolymer that may have as much as 10 percent of other diamine(s) substituted for the diamine of the aramid or as much as 10 percent of other diacid chloride(s) substituted for the diacid chloride of the aramid. A p-aramid would be preferred in a fabric as used in this invention, and poly(p-phenylene terephthalamide) (PPD-T) is the preferred p-aramid. M-aramids may also find use in the present invention, and poly (m-phenylene isophthalamide) (MPD-I) is the preferred m-aramid. P-aramid and m-aramid fibers and yarns particularly suitable for use in the present invention are those sold respectively under the trademarks Kevlar® and Nomex® (E. I. du Pont de Nemours and Company, Wilmington Del., USA), and Teijinconex®, Twaron® and Technora® (Teijin Ltd., Osaka, Japan), and equivalent products offered by others.

The shell may further comprise a chemically protective membrane, or a composite film or laminate that comprises a chemically protective membrane. The chemically protective membrane, composite film or laminate may be bonded to the shell continuously or discontinuously using adhesives, stitching, zippers, snaps, buttons, string, or other connecting devices common in the garment textiles industry. In one example of discontinuous bonding, the edges of the shell and a chemically protective laminate are sewn together, an arrangement often referred to as a “hung liner”. The use of adhesives in discontinuous patterns such as dots is preferred.

### Chemically Protective Membrane

The chemically protective membrane may be any of a variety known in the manufacture of chemically protective garments, shelters, and coverings and is selected based on the nature of protection required. Additionally, the chemically protective membrane can extend the useful life of the adsorptive liner by protecting it from many external adsorbates.

In one embodiment, the chemically protective membrane is a selectively permeable membrane (“SPM”) that has a moisture vapor transport rate sufficient to promote the comfort of the wearer, while the transport rate of materials harmful to human health is low enough to prevent the occurrence of injury, illness or death. The specific transport rate needed will necessarily depend on standards for the specific harmful substance; for example, NFPA 1994, 2006 Revision requires <4.0 μg/cm² one hour cumulative permeation for mustard and <1.25 μg/cm² for the nerve agent Soman. Permeability to specific harmful substances may be determined by various methods including, without limitation, those described in ASTM F739-91, “Standard Test Method for Resistance of Protective Clothing Materials to Permeation by Liquids or Gases Under Conditions of Continuous Contact”; ASTM F903, “Standard Test Method for Resistance of Protective Clothing Materials to Penetration by Liquids;” ASTM F1001 Chemical Test Battery; ASTM F1670, “Resistance of Materials Used in Protective Clothing to Penetration by Synthetic Blood”; and ASTM F1671, “Resistance of Materials Used in Protective Clothing to Penetration by Blood-Borne Pathogens Using Phi-X174 Bacteriophage Penetration as a Test System”.

SPM's useful in this embodiment may comprise any of a variety of polymers, including without limitation polyurethanes; polyether block polyamide copolymers (“PEBA”), polyether block polyester copolymers (“PEBE”); cellulose-based polymers; vinyl alcohol(co)polymers; perfluorinated sulfonic acid tetrafluoroethylene copolymers (such as Nafion® perfluorosulfonic acid tetrafluoroethylene copolymer, available from E. I. du Pont de Nemours and Company, Wilmington, Del., USA); highly fluorinated ion exchange polymer having sulfonic acid multivalent metal ion salt functional groups, such as those described in U.S. Pat. No. 4,515,761; and those SPM's described in U.S. Pat. No. 5,391,426 (crosslinked polyalkyleneimine wherein the alkylene moiety is 2 to 8 carbon atoms); U.S. Pat. No. 5,824,405 (polyimides, especially 5,5′-carbonylbis[1,3-isobenzofurandione], polymer with 2,4-diisocyanato-1-methylbenzene and 1,1′-methylenebis[4-isocyanatobenzene]) U.S. Pat. No. 6,395,383 (polyamine polymer wherein at least 10% of the polyamine polymer amines are amine-acid moieties wherein the acidic species of said amine-acid moieties have a pKₐ less than 6.4); U.S. Pat. No. 5,743,775 (cellulose-based polymers); U.S. Pat. No. 6,792,625 (cellulose-based polymers, polytetrafluoroethylene, polyester, polyurethane); and applications WO 2005/021100 A2 (sulfonated aromatic polymer comprising at least one repeating aromatic group selected from 5,6, or 7-membered single or fused rings having 0 to 4 heteroatoms selected from N, O or S, and at least a portion of the aromatic groups have at least one pendant group comprising sulfonic acid, or its salt); U.S. patent application Ser. No. 11/079,121 (polyalkylamine in a polyurethane network), Ser. No. 11/593,958 (chitosan and its derivatives), and Ser. No. 11/611,486 (acid polysaccharides, including polysaccharides that contain acidic functional groups that are ionizable and salts of such polysaccharides.), all of which are hereby incorporated by reference in their entirety.

In another embodiment, the chemically protective membrane allows vapor transport but is a barrier to liquid. Examples include without limitation spun-bonded polyolefin, an example of which is DuPont™ Tyvek® spun-bonded olefin (E. I. du Pont de Nemours & Co., Inc., Wilmington, Del., USA); expanded polytetrafluoroethylene membranes such as those sold under the trademark GORE-TEX® (W. L. Gore & Associates, Inc., Newark, Del., USA); hydrophobic polyurethane microporous membranes (see, e.g., S. Brzeziński et al., Fibres & Textiles in Eastern Europe, January/December 2005, 13(6), 53-58); and microporous polypropylene available from, e.g., 3M (St. Paul, Minn., USA).

In a further embodiment, the chemically protective membrane is largely impermeable to both water vapor and specific materials harmful to human health. These impermeable membranes comprise polymer materials including without limitation butyl rubber, tetrafluoroethylene (co)polymers, fluoroelastomers (e.g., Viton® fluoroelastomer, E.I. du Pont de Nemours & Co., Inc., Wilmington, Del., USA), polychloroprene, vinylidene chloride(co)polymers, PET film, metallized polymer film, vinyl chloride(co)polymers, acrylic(co)polymers, acrylonitrile(co)polymers, and ethylene vinyl alcohol copolymers.

### Chemically Protective Article Design

The design of the chemically protective articles of this invention is limited only by the capability for detaching and re-attaching the adsorptive liner to the shell. In a garment, the shape of the separable liner will generally conform to the shape of the shell in such a way that most, if not all, portions of the body covered by the shell are likewise covered by the separable liner. Attachment points between the shell and the liner will typically occur at the wrist, ankle, and neckline and near closures such as zippers. Other attachment points may be desirable, for example in the seat or lower back, to maintain alignment of the liner with the shell. Attachment is accomplished by any appropriate reversible connecting means including without limitation hook and loop fasteners such as VELCRO® brand fasteners (Velcro Industries, B.V.), zippers, buttons, snaps, strings, and other reversible closure devices.

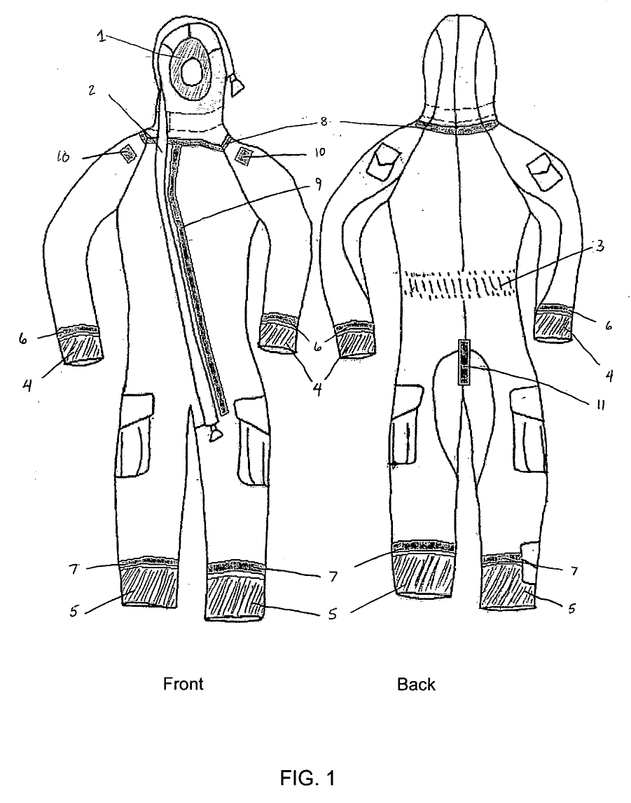

To demonstrate one embodiment of the present invention, a one-piece protective garment with an integrated hood was made as illustrated by FIG. 1. The external shell was made of a woven blended fabric of nylon (50%) and cotton (50%) bonded to a PEBA film (13 μm thick) with polyurethane adhesive dots. An attached butyl-rubber face-piece interface (hatched area 1 in front view) provided an interface for a respirator mask or the mask of a self-contained breathing apparatus (“SCBA”) on the hood. A single, long, chemical resistant, zipper (2) provided a means of donning and doffing the garment. An elastic strip was attached inside the shell across the lower back (3 in back view) to help the garment conform more closely to the body. Cuffs at the wrist (hatched areas) (4) and ankles (5) were designed for interface with appropriate gloves and footwear. Strips of the “hook” portion of hook and loop fasteners were attached with adhesive inside the shell at the cuffs (shaded areas) (6), the legs (7), the neck (8), the zipper (9), the shoulders (10), and lower back (11). The separable liner conformed to the torso, arms and legs of the garment but did not include the hood. The liner was made of Zorflex® activated carbon cloth bonded to a lightweight woven polyester fabric by means of polyurethane adhesive dots. Strips of the “loop” portion of “hook and loop fasteners” were attached to the liner in conformance with their attachment points on the shell.

Many design variations are possible. For example, the separable liner could include coverage of the head by attachment to the inside of a hood, the arrangement of the zipper may be changed, and the gloves and/or footwear may include separable adsorptive liners.

### Uses

The chemically protective garments, shelters, and protective covers of the present invention may be used to protect against harm or injury as caused by exposure to toxic chemical and/or biological agents, including without limitation those agents potentially used in a warfighter environment and materials identified as “Toxic Industrial Chemicals” (TICs) or “Toxic Industrial Materials” (TIMs); see, for example, Guide for the Selection of Chemical and Biological Decontamination Equipment for Emergency First Responders, NIJ Guide 103-00, Volume I, published by the National Institute of Justice, U.S. Department of Justice (October 2001), herein incorporated by reference. A few examples of TICs are phosgene, chlorine, parathion, and acrylonitrile.

In one embodiment, the chemically protective garments, shelters, and chemically protective covers of the present invention are useful to protect military personnel against dermal exposure to chemical and biological agents potentially encountered in a warfighter environment. Examples of such agents include without limitation nerve agents such as Sarin (“GB,” O-isopropyl methylphosphonofluoridate), Soman (“GD,” O-Pinacolyl methylphosphonofluoridate), Tabun (“GA,” O-Ethyl N,N-dimethylphosphoramidocyanidate), and VX (O-Ethyl S-2-diisopropylaminoethyl methylphosphonothiolate); vesicant agents such as sulfur mustards (e.g., Bis(2-chloroethyl)sulfide and Bis(2-chloroethylthio)methane); Lewisites such as 2-chlorovinyldichloroarsine; nitrogen mustards such as Bis-(2-chloroethyl) ethylamine (“HN1”); tear gases and riot control agents such as Bromobenzyl cyanide (“CA”) and Phenylacyl chloride (“CN”); human pathogens such as viruses (e.g., encephalitis viruses, Ebola virus), bacteria (e.g., Rickettsia rickettsii, Bacillus anthracis, Clostridium botulinum), and toxins (e.g., Ricin, Cholera toxins). A human pathogen is a microorganism that causes disease in humans.

In a further embodiment, the chemically protective garment of the present invention is useful to protect first responder personnel from known or unknown chemical or biological agents potentially encountered in an emergency response situation. In yet another embodiment, the chemically protective garment is intended to protect cleanup personnel from chemical or biological agents during a hazmat response situation. Examples of hazardous material in addition to those listed above include certain pesticides, particularly organophosphate pesticides. Furthermore, the chemically protective garment can be used in various medical applications as protection against toxic chemical and/or biological agents.

In another embodiment, the chemically protective garment is an item of outerwear or sportswear and the primary function of the adsorptive liner is to adsorb odor.

Such garments include without limitation coveralls, protective suits, coats, jackets, raingear, ski pants, gloves, socks, boots, shoe and boot covers, trousers, hoods, hats, masks, and shirts.

In another embodiment, the chemically protective garments are medical garments for health care workers, such as medical or surgical gowns, gloves, slippers, shoe and boot covers, and head coverings.

Yet another embodiment of the present invention is a chemically protective covering comprising a separable adsorptive liner, for example, a tarpaulin, equipment cover, storage container cover, or sleeping bag.

A further embodiment of the present invention is a shelter comprising a separable adsorptive liner. Examples include without limitation tents, chemically protective shelters designed for military use, safe rooms in commercial and residential buildings, clean rooms in which to perform surgical procedures, clean rooms in which to conduct activities requiring high air purity such as computer chip fabrication, and storage sheds. Separable adsorptive liners could be used in temporary, soft-walled construction (i.e., wherein the wall material used to enclose a space is flexible plastic sheeting or fabric as opposed to rigid materials such as “sheet rock” (wall board), wood, concrete, or metal) or in permanent construction.

One example of a soft-walled shelter suitable for use in the present invention is a Chemical-Biological Protective Shelter developed for the military that a 300-square-foot semi-cylindrical airbeam-supported soft shelter that can be inflated in four minutes and made fully operational in less than 20 minutes.

Another shelter suitable for use in the present invention is a “TEMPER tent” (acronym for “The Tent, Extendable Modular Personnel”) a modular, soft-walled, aluminum framed supported tent made of vinyl coated polyester cloth, designed for military use. Modules can be combined in various configurations and used for a variety of functions, such as including field feeding, latrines, administrative offices, shops, kitchens, shower/shave units and medical facilities. A protective separable adsorptive liner could be attached to the inner surface of the tent.

Another shelter for military applications suitable for use in the present invention is an “ISO Shelter,” which is a cargo transporter modified to be utilized as a communications shelter, tool or maintenance kit, unit support van, or mobile command post, etc. A chemically protective separable adsorptive liner could be attached to the inner surface of the shelter walls and roof.

Another shelter for military applications suitable for use in the present invention is a combat support hospital, for example, using “CP DEPMEDS” (acronym for “Chemically Protected Deployable Medical System”) equipment. This is an integrated facility combining TEMPER tents, ISO Shelters, and covered passageways, any or all of which could incorporate the separable adsorptive liner described here.

What is claimed is:

1. A chemically protective article garment, shelter, or chemically protective covering comprising a shell and a separable liner, wherein the separable liner comprises adsorptive material and wherein the chemically protective article is a garment, shelter, or covering.

2. The chemically protective article according to claim 1 wherein the adsorptive material comprises at least one member selected from the group consisting of silica gel, alumina, other metal oxides, metal hydroxides, molecular sieves, zeolites, and activated carbon.

3. The chemically protective article according to claim 2 wherein the activated carbon is in the form of powder, beads, granules, nanotubes, fiber, or non-woven, woven or knit cloth.

4. The chemically protective article according to claim 3 wherein the activated carbon is attached to a woven or non-woven fabric.

5. The chemically protective article according to claim 3 wherein the activated carbon is dispersed in a foam and the foam is supported on a fabric.

6. The chemically protective article according to claim 3 wherein the non-woven, woven or knit carbon cloth is bonded to another woven or knit fabric by a connecting means.

7. The chemically protective article according to claim 6 wherein the connecting means is selected from the group consisting of adhesive, stitching, zippers, snaps, buttons, and string.

8. The chemically protective article according to claim 7 wherein the connecting means is a discontinuous pattern of dots of adhesive.

9. The chemically protective article according to claim 1 wherein the separable liner is attached to the shell by a reversible connecting means.

10. The chemically protective article according to claim 9 wherein the reversible connecting means is selected from the group consisting of hook and loop closures, zippers, buttons, and snaps.

11. The chemically protective article according to claim 1 wherein the shell comprises a woven or non-woven fabric.

12. The chemically protective article according to claim 11 wherein the woven or non-woven fabric is selected from the group consisting of nylons, cotton, polyesters, modacrylic, aramids, and blends containing any of these.

13. The chemically protective article according to claim 1 further comprising a chemically protective membrane.

14. The chemically protective article according to claim 13 wherein the chemically protective membrane is a selectively permeable membrane.

15. The chemically protective article according to claim 14 wherein the selectively permeable membrane comprises a polymer selected from the group consisting of polyurethanes; polyether block polyamide copolymers: polyether block polyester copolymers; cellulose-based polymers; vinyl alcohol(co)polymers; perfluorinated sulfonic acid tetrafluoroethylene copolymers; highly fluorinated ion exchange polymer having sulfonic acid multivalent metal ion salt functional groups, crosslinked polyalkyleneimine wherein the alkylene moiety is 2 to 8 carbon atoms; polyimides; polyamine polymer wherein at least 10% of the polyamine polymer amines are amine-acid moieties wherein the acidic species of said amine-acid moieties have a pKₐ less than 6.4; polytetrafluoroethylene, polyesters; sulfonated aromatic polymer comprising at least one repeating aromatic group selected from 5,6, or 7-membered single or fused rings having 0 to 4 heteroatoms selected from N, O or S, and at least a portion of the aromatic groups have at least one pendant group comprising sulfonic acid, and its salt; polyalkylamine in a polyurethane network; chitosan and its derivatives; acid polysaccharides, including polysaccharides that contain acidic functional groups that are ionizable and salts of such polysaccharides.

16. The chemically protective article according to claim 13 wherein the chemically protective membrane is selected from the group consisting spun-bonded polyolefin, expanded polytetrafluoroethylene membranes, hydrophobic polyurethane microporous membranes, and microporous polypropylene.

17. The chemically protective article according to claim 13 wherein the chemically protective membrane comprises polymer material selected from the group consisting butyl rubber, tetrafluoroethylene(co)polymer film, fluoroelastomers, polychloroprene, vinylidene chloride(co)polymers, poly(ethylene terephthalate) film, metallized polymer film, vinyl chloride(co)polymers, acrylic(co)polymers, acrylonitrile (co)polymers, and ethylene vinyl alcohol copolymers.

18. The chemically protective garment according to claim 1 wherein the chemically protective garment is selected from the group consisting of coveralls, chemically protective suits, coats, jackets, raingear, ski pants, gloves, socks, boots, shoe or boot covers, trousers, hoods, hats, masks, shirts; and medical garments selected from the group consisting of medical and surgical: gowns, gloves, slippers, shoe and boot covers, and head coverings.

19. The chemically protective covering according to claim 1 wherein the chemically protective covering is selected from the group consisting of tarpaulins, equipment covers, storage container covers, and sleeping bags.

20. The shelter according to claim 1 wherein the shelter is selected from the group consisting of tents, chemically protective shelters designed for military use, safe rooms, clean rooms, and storage sheds.

21. The chemically protective shelter designed for military use according to claim 20 wherein the chemically protective shelter is a combat hospital, modular tent, covered passageway, or ISO Shelter.

22. The chemically protective shelter according to claim 20 wherein said shelter is soft-walled.
